(19) United States
(12) Patent Application Publication
(10) Pub. No.: US 2009/0055421 A1
(43) Pub. Date: Feb. 26, 2009

(54) Migration and transformation of data structures

(76) Inventor: Veit Florian Lier, Aspach (DE)

Correspondence Address: SHLESINGER, ARKWRIGHT & GARVEY LLP, 1420 KING STREET, SUITE 600, ALEXANDRIA, VA, 22314, US

(21) Appl. No.: 11/991,069

(22) PCT Filed: Aug. 30, 2005
(86) PCT No.: PCT/EP2005/009340

§ 371 Date: Feb. 27, 2008

(51) Int. Cl. G06F 17/30

(52) U.S. Cl. 707/101; 707/E17.044

(57) ABSTRACT

The invention relates to a functional unit for the migration and transformation of data structures from at least one source system into data structures of at least one target system comprising at least one import filter and at least one export filter. The at least one import filter is for transformation of a data structure prepared by the source system in a source-system dependent format into a universal description format. The at least one export filter is for transformation of the data structure in the universal description format into a target-system dependent format and to provide the same for the target system.

The invention relates to a functional unit, a system, a description frame, a process for transforming a data structure, a computer programme and a computer programme product.

Numerous translation processes are already known for migrating or transforming configurations of IT or data bank systems between different platforms. However, only data are transformed in such migrations. Applications which contain the data, as well as their structure and configuration, are not taken into account. Therefore, up till now it has been too laborious to convert existing infrastructures.

Against this background, the invention proposes a functional unit having the features of claim 1, a system having the features of claim 8, a description frame having the features of claim 9, a process having the features of claim 10, a computer programme having the features of claim 20 and a computer programme product having the features of claim 21.

The functional unit according to the invention is suitable for the migration and transformation of data structures from at least one source system into data structures of at least one target system and comprises at least one import filter and at least one export filter. The functional unit is designed to form a link between at least one source system and at least one target system. The at least one import filter is configured so as to transform a data structure which is in a format dependent on the source system into a universal description format. The at least one export filter is configured so as to transform the data structure which is in the universal description format into a format dependent on the target system.

Generally speaking, IT systems provide possible ways of storing data in databank systems. The construction of these storage systems, i.e., for example, the name of the tables and the name and specification of these fields, such as the number type, date type, etc, is generally referred to as the “data structure”.

Within the scope of the present invention, the term “data structure” refers however to the structure of an IT system under consideration, i.e. the source or target system, or their respective configurations. Accordingly, the term “data structure” encompasses not only a definition of storage media used but also a processing programme logic used accordingly and input and display surfaces available, a so-called user front end and administrative design elements.

The core of the present invention is the migration and transformation of the configuration of IT systems, i.e. the configuration of the source system and the configuration of the target system, between different platforms, and not only the migration of the data contained in the respective systems.

“Data structure” in the context of the present invention shifts the focus onto the structure of the configuration, which may also contain data in the true sense but need not do so.

The functional unit according to the invention may have an import filter for each source system and an export filter for each target system. During analysis of the data structure in the format dependent on the source system, this structure is broken down into structural elements. These structural elements are checked and/or identified and then compared with structural elements stored in a configuration table. This process is referred to as “parsing” (English for analysing) the data structure. A so-called DOM-parser (Document Object Model) can be used to break a data structure down into structural elements and provide them in a so-called syntax tree for further processing. New structural elements can be incorporated in the configuration table. In this way the functional unit can expand continuously.

Structural elements categorised as unidentifiable but present in the data structure can be incorporated in a protocol provided for structural elements of this kind and in an additional step can be analysed and transformed, optionally by means of an administrator unit. A structural element dependent on the source system or conforming to the source system can be translated through the import filter into a structural element of the universal description format and, from there, through the export filter, into a structural element dependent on or conforming to the target system.

The universal description format may also be referred to as a description format which is intersystemic between two systems, i.e. between the at least one source system and the at least one target system. The universal description format is to be understood as an auxiliary format by means of which it is possible to carry out transformation and migration between the format dependent on the source system and the format dependent on the target system. The universal description format can accordingly be regarded as a generally valid or overarching format among source system-dependent and target system-dependent formats.

Further features of the present functional unit will be apparent from the dependent claims 2 to 7. The functional unit is particularly designed to carry out at least one step of the process according to the invention set out hereinafter.

The present invention further relates to a transformation system having the features of claim 8. This transformation system is provided for the migration and transformation of data structures from at least one source system into data structures of at least one target system. The transformation system comprises at least one source system, at least one target system and a functional unit connected between the at least one source system and the at least one target system, the functional unit having at least one import filter and at least one export filter. The at least one import filter is designed to transform a data structure provided by the source system and provided in a source system-dependent format into a universal description format, and the at least one export filter is designed to transform the data structure which is in the universal description format into a target system-dependent format and provide it to the target system.

The present invention also includes a description frame, a so-called framework, having the features of claim 9. The description frame according to the invention is suitable for the transformation and migration of a data structure from at least one source system into at least one target system and is designed so as to present a data structure which has been provided by the at least one source system, and which is present in a source system-dependent format and transformed by at least one import filter, in a universal description format, and to transform the data structure presented in the universal description format into a target system-dependent format by means of at least one export filter.

The process according to the invention which is also provided by the invention is intended for migrating and transforming a data structure from at least one source system into at least one target system. In the process, the data structure provided by the at least one source system and present in a source system-dependent format is transformed by means of at least one import filter into a data structure which is present in a universal description format. The data structure present in the universal description format is transformed by means of at least one export filter into a data structure which is present in a target system-dependent format and is provided to the at least one target system.

Other advantages of the process according to the invention will become apparent from the dependent claims 11 to 19. It is envisaged that the process can be carried out in particular by the functional unit according to the invention.

In a preferred embodiment, the at least one import filter and the at least one export filter may be capable of being derived from a source code by the processing frame according to the invention. This source code can be generated from structural information stored in a configuration table or a configuration file.

The computer programme with programme coding means according to the invention is suitable for carrying out all the steps of the process according to the invention when the computer programme is run on a computer or a corresponding computer unit, particularly in the functional unit according to the invention.

The novel computer programme product with programme coding means stored on a computer-readable data carrier is designed to carry out all the steps of the process according to the invention when the computer programme is run on a computer or a corresponding computer unit, particularly in the functional unit according to the invention.

The present invention constitutes a preferably software-supported solution for the two-way migration and transformation of data structures, e.g. different data bank systems or different data processing applications using different development platforms. The data structures are based for example on the XML format (extensible mark up language). Migration and transformation of data bank systems and data processing applications using different development platforms based on XML are made possible by the present invention. However, any other suitable format besides the XML format is also possible.

Numerous databank and IT systems allow the display of logic and configuration elements which are to be processed in an XML format. The functional unit according to the invention, which, together with its components, may hereinafter be referred to as D² (D squared), transforms these data structures which are generally present in manufacturer- and system-dependent XML formats or displays into a universal description format starting from the at least one source system, by means of the at least one import filter. The data structures displayed in the universal description format are hereinafter referred to as D² objects. By the reverse use of the functional unit according to the invention, in a second step this data structure can be transformed again by means of at least one preferably dedicated export filter into a manufacturer- and system-dependent XML format which is valid for and in conformity with the at least one target system, so that the logic to be processed and the configuration elements are now displayed in a target system-specific XML format.

All computer systems that allow their configuration to be displayed in XML or XML dialects such as Lotus Domino, MS Office 2003, Net, etc, can be supported.

The description frame according to the invention, hereinafter referred to as the D² framework, tied into the functional unit, is based on a procedure for the interpretation and migration of data structures which is independent of any programming language and self-learning. The data structures may be applications, as already mentioned previously.

Possible uses of the functional unit according to the invention and/or of the process according to the invention can be found for example in the following fields: the analysis of conversion expenditure, migration of IT systems and/or modification of IT systems.

By importing existing applications into the description frame of the functional unit a code on which the applications are based is checked and identified. As a result, it is possible to analyse the conversion costs of a data structure from a source system into a target system.

Translatable structural elements of the source system-dependent data structure or corresponding configuration elements such as programme coding elements are identified as “positive” and present no problems within the scope of a planned conversation. Untranslatable structural elements are identified as “negative” in the analysis of the source system-dependent data structures and are written into a protocol provided for negative structural elements of this kind.

This protocol can be processed accordingly by additional means, so that a suitable translation is provided for structural elements identified as negative and this translation is incorporated in the configuration table for future use. If this protocol is evaluated with time and/or material costings, realistic estimates for the planned conversions can be achieved by aggregating them.

In the case of a migration for IT systems, existing structural elements or an existing configuration of the source system are read out and converted into an analogous configuration in terms of the form structure, presentation of data, processing logic, etc, in the chosen target system. As the source system is not modified in the process, the integrity of its data and functions is guaranteed.

After migration has taken place, the newly created data structure or application can be tested and evaluated with regard to its functionality. If no problems have arisen during the migration, the source system-dependent data structure can be removed. If in the course of the migration hitherto unknown coding elements have been identified in the source system, these are recorded in the protocol (D² log) of the functional unit. These known coding elements or structural elements identified as “negative” can be revised and/or noted during evaluation of the protocol, so that a suitable translation can be allocated to these coding elements or structural elements within the scope of the universal description format.

There is now the possibility of expanding the existing import and export filters and in a further migration run achieving a more complete and hence better result. In this way, complex migration projects can be run in modular and application-based manner and automatically concluded on a fixed date.

Many IT systems used in a business or organisation are of considerable age and were set up in accordance with the technical possibilities available at the time of the development, which is why a modification of these IT systems might have to be considered. A manual upgrade to the current state (status quo) of technical progress involves high risk in terms of cost and time. Generally, many simple individual steps have to be performed manually at this stage, such as adapting the date model, amending field names and designations, etc.

These steps can be automated by means of the functional unit according to the invention. This means that for exporting the data structure the corresponding inverse import filter is used. If for example an import filter is used to transform a data structure from MS Word according to D², the corresponding inverse import filter conversely serves to transform D² according to MS Word as an export filter. For this, the import and export filters must be configured in inverse manner to one another. Accordingly, in a preferred embodiment, with an import filter and a corresponding export filter it is possible to carry out bidirectional transformation of a data structure which is present in a specific format dependent on a first system into the universal or generally valid description format and vice versa. This particular first system may be used both as a source system by the import filter and as a target system by the corresponding export filter.

The transformation of the data structure takes place in two stages. In a first stage the data structure which is in the source system-dependent format is transformed by the import filter into the universal description format by analysis, identification and allocation of structural elements. This import filter can generate itself from the data structure transmitted and the information deposited or capable of being provided in a configuration system, by processing, modifying and supplementing structural elements. This import filter is thus a so-called self learning code. The information on the data structure present in the now universal description format is temporarily stored in the universal description frame of the functional unit. Storage may be in a hierarchical class model or class system, while this class model is transferred on the basis of the structural elements read in during transformation or migration from the at least one source system, or a corresponding data structure.

The data structure present in the general description format may be migrated in a second step by analysis, identification and allocation of structural elements, into any desired target system or a corresponding platform for which the export filter is provided. The export filter identifies the structural elements stored in the description frame, e.g. draft or design elements or code components, and transfers them into the target system-dependent format which can be interpreted by the target system. Unknown or non-existent structural elements within the target system are recorded and included during this process for documentation purposes, these structural elements can subsequently be commented out and processed and in particular manually translated by an administrator unit. In this way, data processing systems can be transferred from a first platform or source system to any other desired supported second platform or target system via an intermediate step of the universal description frame including storage in the universal description format.

In particular, all platforms or systems that are able to consult XML files or their derivatives to define structural elements such as lay out and code, e.g. Lotus Domino, MS Office 2003, Net, etc, are supported. It is envisaged that access will be available to the universal description frame during this transformation using any programming language that allows the tying in of external coding resources, in this case in a programming interface (D² API application programming interface) of the functional unit, e.g. Lotus Script, Java, VB, etc.

Besides the actual migration of applications, with the functional unit it is possible for example to estimate the expenses that can be expected from the conversion of an IT system or an overview of a code quality of applications under consideration.

Thus, with the functional unit according to the invention or the universal description frame, it is possible to analyse an IT infrastructure and to acquire an estimate of what percentage of the data structures or applications connected with this IT infrastructure can be migrated easily, with difficulty or perhaps not at all. If the results thus obtained, arising from the protocol, are put into a so-called normal form in which every unknown element appears only once, so that the results are presented clearly, it is possible to obtain a simple estimate of the resources and costs that would be swallowed up by a conversion. If a user finds this estimate to be reasonable and acceptable, the conversion of the original system, i.e. the source system, can be carried out automatically by means of the universal description frame or the functional unit, for example by removing Word forms or Excel spreadsheets.

As a rule, migrations between platforms or systems are either carried out manually or an individual code is produced which allows conversion from a first system to a second system. By using a global filter or a transformation filter of the functional unit according to the invention which encompasses the import filter and the export filter, it is possible to open up a new platform or the target system in two stages. In a first stage an import filter can be created from the source system-dependent data structure or application in the universal description format. In a second stage, a corresponding export filter can be produced for the target system-dependent data structure. For this purpose, according to one embodiment, the processing frame generates a source code from structural information deposited in configuration tables for the respective data structures and the import and export filters can then be derived from these source codes. When both filters are present, this source system is tied into the universal description frame and can be used at any time. This results in considerable potential savings. Compared with previous procedures, there is a considerable reduction in costs and faster conversion, as the actual work of transformation is now taken on by the functional unit according to the invention. With the functional unit according to the invention it is possible to raise existing applications onto a new platform or to transform them into the target system, thus providing a substantially simpler and faster migration process.

The functional unit according to the invention may cover a considerably wider ranging spectrum of platforms and systems, i.e. source and target systems, as it is based on dynamic import filters and export filters. During a running period, the functional unit analyses a code that has been input and if necessary expands the configuration table stored. This configuration table can be checked and modified by an administrator so that the user can adapt the functional unit individually to his requirements, thus enabling the user to decide what options are available to him with the functional unit. Any errors that might possibly arise during the transformation or translation of the code or a configuration are simply configuration problems and can be adjusted at a later stage without making it absolutely essential to update the software-based functional unit. The user is thus in a position to analyse his existing infrastructure and from it derive an estimate of costs for the transformation and focus on identifying problems. Thus the user is provided with a broader spectrum of functionalities.

The functional unit according to the invention and the universal description frame according to the invention as part of the functional unit provide the possibility of developing a global storage possibility for data structures occurring in all kinds of formats, particularly XML formats. The hierarchical and optionally generalised class model may preferably be used to store the data structures.

With the functional unit or the universal description frame it is also possible to reduce substantially a number of translation filters required for the transformation. Starting from 6 different platforms or systems, for example, a total of 30 transformation filters are needed for these 6 platforms as each system has to be translated into 5 other systems. By using the functional unit according to the invention as a global container that encompasses the import and export filters, and using the universal description format, a number of transformation filters required is reduced to 2 for each system or platform used. Accordingly, only one import filter and one export filter is required for each system. Starting with a total of 6 platforms or systems, with the functional unit described here only 12 transformation filters are required, i.e. 6 import filters and 6 export filters.

In addition to a reduction in the filters needed and hence the codes required, the functional unit is self learning, in that the functional unit incorporates new structural elements into a configuration table and automatically expands basic programming interfaces (D²-API) and adapts them to the new circumstances. The functional unit can accordingly adapt automatically to the changes occurring when there are new versions of source or target data from corresponding source or target systems.

The functional unit makes it possible to open the data structure present in a source system-dependent format, e.g. in an XML format, i.e. a file or application, and transforms the structural elements contained therein into a target system-dependent data structure and automatically imports this. Structural elements which cannot be translated without errors are noted accordingly and flagged up in the protocol. The user of the functional unit can tell from this protocol what has to be done and what corrections are still needed before this component or this application precisely satisfies the requirements which were imposed on the original file or application. All the activities of the functional unit can be sorted, flagged up and evaluated in a report according to the application, user, date or nature of individual steps carried out. A user front end or programming front end which is used for an interactive request, inputting and displaying of data and can also be referred to as a user surface, is based on the elements of a design study for establishing an intuitive front end and converts these as far as is possible from a technical point of view.

The functional unit according to the invention is particularly suitable for users or businesses that are considering going in the direction of computer supported cooperation (“CSCW” (computer supported collaborative work) or groupware). A competitive situation in this market lends itself to the use of the functional unit and the process. The functional unit is suitable for businesses which have a high need for support by largely automated tools in the IT field. The functional unit gives these businesses the opportunity of rethinking their IT strategy against the background of systems currently in use, in this case source systems, and if necessary improving them by conversion or transformation into more modern, powerful systems, i.e. target systems.

The description frame of the functional unit according to the invention may be constructed so that the requirements of the standard “DIN EN ISO 9241 Part 10” are taken into consideration in this design of the user front end and can be implemented as far as possible. As a result of technical considerations, particular emphasis may be placed on the following aspects:
that is should be appropriate for its purpose, by the use of standard values and selection fields for reducing errors,
that it should have a self-writing capability by the use of status lines, cost-extensive aids or remarks,
that it should be controllable, with input possibilities using a so-called wizard for beginners or more complex masks for experts,
there is conformity of expectation due to the consistent form of all interaction possibilities by the arrangement of actions.

With the functional unit, the XML format in particular can be used innovatively. Originally XML was intended as a data exchange format between IT systems, e.g. web services. With the transformation of data structures, i.e. applications, data or configurations, that can be carried out by means of the process or the functional unit, the XML format can be used innovatively, by making use of XML import and export options to shut down or set up systems.

When the process according to the invention is carried out or the functional unit according to the invention is used, not just letters or words but whole structural elements are transformed or replaced, including their technical content, with respect to an application.

For practical use, three different scenarios, in particular, appear to be viable and lucrative:

1) Estimating Costs in the Run Up to a Migration:

During a migration of the data structure from the source system, i.e. a source application into the universal description format, the functional unit carries out an analysis of the structural elements and hence of a code of this data structure. Within the scope of this analysis, unknown or untranslatable structural, code and/or design elements are recorded. The contents of the report thus produced are the total of all the structural elements or fragments that cannot be translated automatically. It has been found that it is identical structural elements in different data structures or applications that cannot be translated, so that only one of several similar structural elements is relevant to a cost estimate and is brought into the normal form. If a structural element of each type of object is evaluated with a pecuniary or time value, an overview is achieved as to the expense which will be incurred during the actual conversion.

2) Carrying Out a Migration:

If a migration is imminent, the IT department or specialist sectors affected have two possible ways of carrying it out: either a) a manual migration, which will generally be very laborious or b) a tool-controlled migration followed by manual checking and correction. As the aspect of quality control crops up in both cases, this can be disregarded during any evaluation. If more than about 20 data structures are to be transformed within the scope of the IT migration, it is advisable from a financial point of view to use the functional unit according to the invention or the process according to the invention.

3) Upgrading Existing Data Structures or Applications:

If the objective is to bring existing data structures up to a unified format and simplify the code logic on which they are based, this can be carried out with the description frame (framework) provided by the functional unit and the programming interfaces (API) contained therein. Using the functional unit it is possible to ensure that all the field names within a system which is to be transformed, particularly a source system or a data bank for conversion, are actually converted. In this scenario, too, it makes sense to use the functional unit from a financial point of view as soon as more than 20 data structures are involved.

Further advantages and embodiments of the invention will become apparent from the description and the attached drawings.

It goes without saying that the features mentioned above and those to be described hereinafter may be used not only in the particular combination specified but also in other combinations or on their own without departing from the scope of the present invention.

The invention is schematically illustrated in the drawings by means of an embodiment by way of example and is described in detail hereinafter with reference to the drawings.

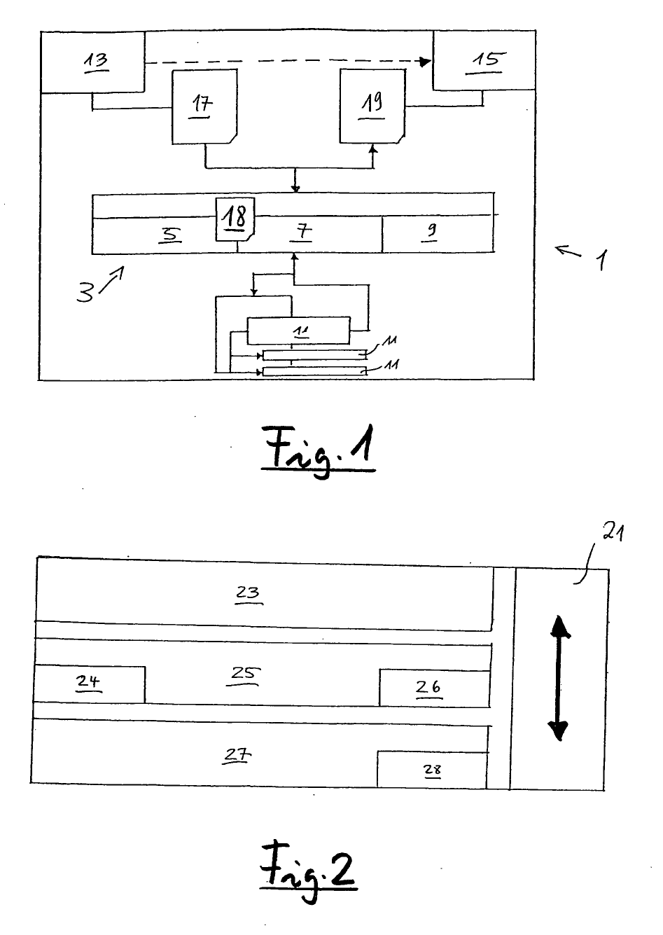

FIG. 1 is a schematic view of a preferred embodiment of a transformation system according to the invention.

FIG. 2 is a schematic view of a preferred embodiment of a planar model of a functional unit according to the invention.

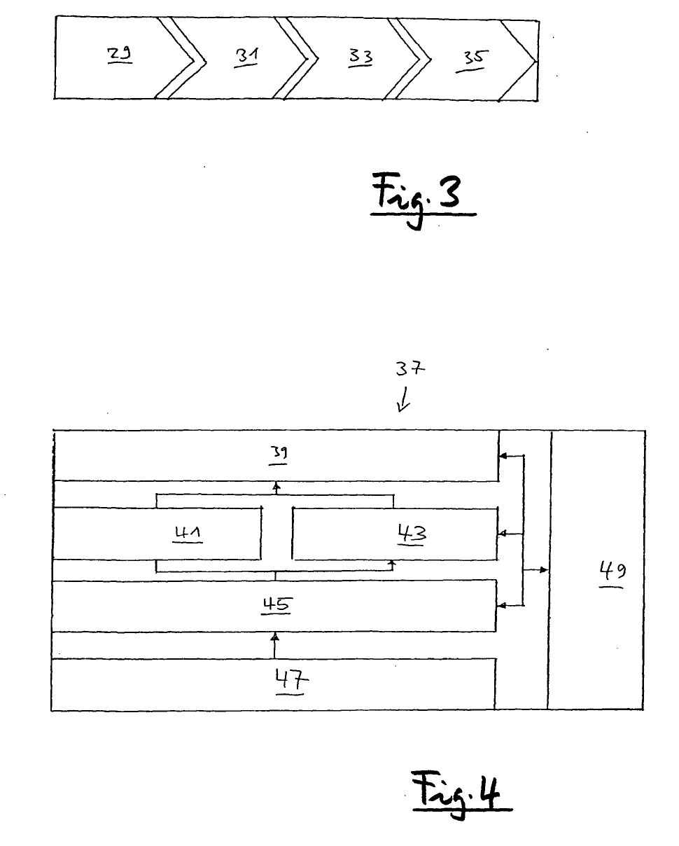

FIG. 3 shows a phase model for carrying out individual stages of a preferred embodiment of a process according to the invention.

FIG. 4 is a schematic view of a preferred embodiment of a description frame according to the invention.

The transformation system 1 schematically shown in a preferred embodiment in FIG. 1 comprises a functional unit 3 which has at least one import filter 5, at least one export filter 7 and at least one programming interface 9 (API). The functional unit 3 or the at least one export filter 7 and the at least one import filter 5 have access to various objects 11 such as, for example, tables required for the transformation, particularly configuration tables or tables of definitions and reports.

If the intention is to transform and/or migrate a data structure which is in a source system-dependent format 17 from a source system 13 into a data structure which is in a target system-dependent format 19 in a target system 15, such a transformation and/or migration may be carried out with the functional unit 3 and using the process that can be carried out by the functional unit 3. It is envisaged that the data structure which is in the source system-dependent format 17 and has been prepared by the source system 13 is transformed via the import filter 5 into a data structure that is in a universal description format 18 and is stored in the functional unit 3. Then the data structure which is in the universal description format 18 is transformed via the export filter 7 into the data structure which is in the target system dependent format 19 and thus prepared for the target system 15. Information is stored in the configuration tables under the objects 11. This information is used during the transformations for interpreting and translating or transferring structural elements into which the data structure in the source system-dependent format 17 is to be broken down. Untranslatable structural elements are recorded in the reports under the objects 11.

The functional unit 3 is therefore a platform and the process is a procedure for automated transformation or migration of computer systems via or between different platforms.

FIG. 2 clarifies in a schematic presentation the procedure for interpreting and migrating data structures or applications. The basis of a description frame of the functional unit in FIG. 1 is the planar model shown in a preferred embodiment in FIG. 2, which is designed to carry out the transformation 21 of data structures, and which comprises a data processing application embedded in a display plane 23, a processing plane 25 with at least one global filter or a corresponding transformation filter which has at least one import filter 24 and at least one export filter 26, and a data plane 27 which comprises the universal description format 28.

The source system-dependent XML representation of the corresponding data structure or a source application is transferred from the source system into the universal description format 28 (D² format) via the at least one import filter 24. If the configuration is intermediately stored in this description format 28, the data structure may be converted, starting from this representation, through the export filter 26 into a target system-dependent XML display which is comprehensible to the target system or a target platform. The functional unit is adjusted by continuous updating to high dynamics in the IT environment and in this way new versions of a software or new design elements and hence also new XML structures can be transformed.

FIG. 3 shows a phase model corresponding to a process of transformation in a preferred embodiment of the process. The process essentially comprises four phases or stages, namely an analysis 29, an expansion 31 or an upgrade, a draft 33 or a design and a transformation 35.

When the process is carried out, a source system-dependent XML file provided is broken down into its structural elements or elements by means of a standard XML parser (DOM parser) during the phase of analysis 29. Each structural element or attribute identified, e.g. an XML node, and each XML attribute is compared against a configuration table. The results of this checking may fall into one of the following categories:

a) The structural element is not yet contained in the configuration table of the functional unit.

b) The structural element is already contained in the configuration table and is not marked or identified therein as being positive, i.e. known and translatable, or negative, i.e. known and untranslatable.

c) The structural element is already contained in the configuration table and is marked as known and interpretable, corresponding to a positive definition of this structural element.

d) The structural element is already contained in the configuration table and is marked as non-interpretable, corresponding to a negative definition of this structural element.

If it is a new structural element (case a), this is incorporated in the configuration table and marked as being unknown. By manual checking this can then be marked either as translatable, i.e. positive, or untranslatable, i.e. negative. If the structural unit is present in the configuration table or the table of definitions (case b), but has not yet been evaluated, the import filter reports that it is an undefined structural element, and this structural element is then included in a report provided for this purpose, so that it can be dealt with individually. If the structural element is contained in the configuration table or table of definitions and marked as being known and interpretable (case c), this structural element is included in the description frame or a D² structure of the import filter. If the structural element has been identified as known but untranslatable (case d), the import filter eliminates a node associated therewith, particularly an XML node.

In the case of a positively defined structural element, it is incorporated in the description frame or a D² structure of the import filter.

As a result of the automatic incorporation of new structural elements in the configuration table or a corresponding table of definitions, the import filter becomes a self-learning system. New situations automatically expand the basic description frame (D² structure).

Positive and negative definitions for structural elements guarantee that only structural elements known to the import and export filters can be imported, and exported into the target system. Besides the automatic expansion of the functional unit, this is the second critical property for carrying out error-resistant transformations and/or migrations of data structures. Negative structural elements which are stored in the report provided for this purpose can be assigned a suitable translation by an administrator.

The next phase in the process is the expansion 31. If the import filter comes across structures or structural elements which are not known to it, these are included in the configuration tables as described previously. On the basis of the now altered configuration table, an object model of the description frame or of the functional unit expands to include the added structural elements and makes a note of them for the future. New object classes are automatically generated and integrated into structural or coding elements which are already tied in.

Once the data structure to be imported has been analysed and the object model has been updated within the scope of the expansion 31, in the process step envisaged as draft 33, the source system-dependent data structure or a source file is moved into a hierarchical class model on the basis of the structural elements or data structure read in during the transformation or migration from the at least one source system and made available to a processing platform (D² platform) of the processing frame. After this phase has ended an importing process is thus concluded and the code read in or the structural elements of the data structure read in, is or are available for further processing.

Analogously to the programme sequence during importing, within the scope of the transformation 35, the information present in the universal description format or stored in a D² structure is validated against the export filter and recorded. Unknown structural or coding elements are not deleted, for reasons of documentation, but included in the report and later commented out. The export filter converts the information stored in the universal description format or D² format into a data structure which is in conformity with the target system, particularly an XML file based on the new allocations and/or translation rules saved in the import and export filters. By expanding the configuration table, the import filter and export filter are improved over time. The import filter automatically expands the general description format as necessary in order to adapt it dynamically to new situations. If new structural suggestions are accepted by an administrator they are permanently available for future use.

FIG. 4 schematically shows the description frame 37 of the functional unit with a programming or user front end 39, the import filter 41, the export filter 43, a class library 45, a basic library 47 and a configuration table 49 which, as indicated by the arrows, interact with one another by exchanging data, information and structural elements.

The processing frame 37 (D² framework) follows an object-oriented programming paradigm and makes use of the properties of the inheritance in current programming languages by the use of classes. The description frame 37 is independent of language, provided that it is possible to integrate code resources in the chosen programming language. In a basic class “DD_Base” global objects can be defined and global functions can be provided. These are available in the system-dependent classes derived from the basic class and use them for standard functions. From the structural information stored in the configuration table 49, the processing frame 37 automatically generates a source code for the manufacturer- and/or system-dependent data structure.

From this source code, import filters 41 and export filters 43 are then derived which carry out a corresponding transformation of data structures between different formats via the API interface stored in the class libraries 45. These import filters 41 and export filters 43 can be accessed and amended via the correspondingly stored programming interface (API), through the corresponding user front end 39 in a selected platform such as, for example, “Domino.Designer” in “Lotus Domino” or “Visual Studio” in “.Net Applications”. All programming languages which allow the integration of external code resources are supported.

The basic library 47 (DD_Base library) represents a basic class on which all the other classes are constructed. It provides basic functions for interpreting XML files and conversion into a class model. Furthermore, the functional unit contains the class-spanning objects needed for further processing, for example a structural tree or basic XML nodes. The XML elements identified in a basic library 47 are incorporated—provided that they are not already present—in the configuration table 49 which serves for a definition of the structural elements. In this way a separate structural tree is dynamically formed for each analysed system or each analysed platform according to the format, e.g. Lotus Domino, MS Word, etc. By means of the class libraries 47 of the functional unit, the information stored in the configuration table 49 is used to dynamically generate the functional unit and the programming interface (API) by means of which the information stored in the D² structure can be displayed. A code which is dynamically produced in this way is automatically documented and versioned and can be accessed as the transformations proceed.

The following properties and methods are made available, for example, for all the attributes of an XML node:
“get<AttributeName>” (reads out the value of the attribute)
“set<AttributeName>” (changes the current value of the attribute)
“append<ElementName>” (inserts a new object of this type into the structure)
“remove<ElementName>” (deletes an existing object of this type)
“New(MyNode as XMLNode)” (starts a new class for this XML element)
“getXMLAsStream(stream_out as Stream)” (converts the current class model into a stream)
“getXMLAsString(str_DDOut as String)” (converts the current class model into a text string)

This produces a uniform and consistent interface (API) which can be accessed by any other desired code.

In order to ensure that the functional unit can be used independently of any system or platform, these class libraries 45 are generated in different programming languages and written as resources into a defined storage location (repository).

The import filters 41 and export filters 43 used by the functional unit in the process access the class libraries 45 and inherit properties and methods from them. Using these functionalities, the information from the XML file is written into the functional unit in the case of an import. In the case of an export the information stored in the functional unit is moved into the corresponding class library 45 and reproduced in a valid XML format. Unknown or known but untranslatable structural elements and/or coding elements are recorded in reports and thus transmitted at the same time after being commented out. Structural elements of this kind must and/or can be post-processed manually in the target system if necessary.

If there is a need to intervene in the transformation process using a programme code, which comprises, for example, to put in update information or produce technical documentation, this is done in the chosen language using the integrated programming interface (API). As already shown, all the properties of the functional unit and the import filters 41 and export filters 43 can be manipulated.

1. Functional unit for the migration and transformation of data structures from at least one source system into data structures of at least one target system, which comprises at least one import filter and at least one export filter, the at least one import filter being designed to transform a data structure provided by the source system and in a source system-dependent format into a universal description format and the at least one export filter being designed so as to transform the data structure which is in the universal description format into a target system dependent format and to provide it to the target system.

2. Functional unit according to claim 1 which is suitable for the two way migration and transformation of data structures of the at least one source system and data structures of the at least one target system.

3. Functional unit according to claim 1 which comprises a universal description frame with a class library and a basic library.

4. Functional unit according to claim 3 in which the basic library is designed to define global objects and to provide global functions and system-dependent classes, the system-dependent classes being designed to make use of these global objects and functions as standard functions.

5. Functional unit according to claim 3 wherein the basic library represents at least one basic class, the basic class representing basic functions for interpreting files and for conversion into a class model.

6. Functional unit according to claim 3, wherein the description frame is designed to generate a source code for the target system dependent data structure from structural information stored in a configuration table.

7. Functional unit according to one of the preceding claims which is designed to carry out a process according to claim 10.

8. Transformation system for the migration and transformation of data structures from at least one source system into data structures of at least one target system, which comprises at least one source system, at least one target system and a functional unit connected between the at least one source system and the at least one target system, the functional unit having at least one import filter and at least one export filter, the at least one import filter being designed to transform a data structure provided by the source system and in a source system-dependent format into a universal description format, the at least one export filter being designed so as to transform the data structure which is in the universal description format into a target system dependent format and to provide it to the target system.

9. Description frame which is designed for the migration and transformation of data structures from at least one source system into data structures of at least one target system, and is designed to represent a data structure which has been prepared by the at least one source system, which is in a source system dependent format and has been transformed by at least one import filter, in a universal description format and to transform the data structure which is represented in the universal description format into a target system dependent format via at least one export filter.

10. Process for the migration and transformation of data structures from at least one source system, into data structures of at least one target system wherein the data structure provided by the at least one source system and present in a source system-dependent format is transformed by means of at least one import filter into a data structure which is present in a universal description format and wherein the data structure which is in the universal description format is transformed by means of at least one export filter into a data structure which is in a target system-dependent format and is provided to the at least one target system.

11. Process according to claim 10, wherein the data structure in the source system dependent format is broken down into structural elements.

12. Process according to claim 11, wherein the structural elements are compared with a configuration table and identified.

13. Process according to claim 10, wherein a new structural element is automatically incorporated in the configuration table.

14. Process according to claim 10, wherein a check is made as to whether structural elements are translatable.

15. Process according claim 10, wherein structural elements are marked.

16. Process according to claim 10, wherein the data structure present in the source system-dependent format is converted into a hierarchical class model and made available to a processing platform.

17. Process according to claim 10, wherein the data structure present in the universal description format is validated against the at least one export filter and recorded.

18. Process according to claim 10, wherein a programming interface is dynamically generated from information saved in the configuration table.

19. Process according to claim 10, which is carried out with a functional unit (3) according to claim 1.

20. Computer programme with programme coding means for carrying out all the steps of a process according to claim 10 when the computer programme is run on a computer or a corresponding computing unit, particularly in the functional unit according to claim 1.

21. Computer programme product with programme coding means which are stored on a computer readable data carrier for carrying out all the steps of a process according to claim 10 when the computer programme is run on a computer or a corresponding computing unit, particularly in a functional unit according to claim 1.
